(19) United States
(12) Patent Application Publication
(10) Pub. No.: US 2022/0134557 A1
(43) Pub. Date: May 5, 2022

(54) CONTROL DEVICE, ROBOT CONTROL SYSTEM, PROGRAM, AND CONTROL METHOD

(71) Applicant: SINTOKOGIO, LTD., Nagoya-shi (JP)

(72) Inventors: Yoshikane TANAAMI, Nagoya-shi (JP); Koji ITO, Nagoya-shi (JP)

(73) Assignee: SINTOKOGIO, LTD., Nagoya-shi (JP)

(21) Appl. No.: 17/509,116

(22) Filed: Oct. 25, 2021

(30) Foreign Application Priority Data
Oct. 30, 2020 (JP) 2020-182413
Oct. 1, 2021 (JP) 2021-162931

(51) Int. Cl. B25J 9/16

(52) U.S. Cl. CPC B25J 9/1664; B25J 9/163

(57) ABSTRACT

In order to attain the object to enable a teacher to easily carry out teaching with enhanced safety of the teacher who is to teach an action to a robot, a robot includes a force sensor, an arm part, and an end effector fixed to the arm part via the force sensor. A control device includes one or more processors that execute a moving process for causing the end effector to move and a generation process for generating, with reference to a detection value from the force sensor, teaching information corresponding to a travel route of the end effector.

This Nonprovisional application claims priority under 35 U.S.C. § 119 on Patent Application No. 2020-182413 filed in Japan on Oct. 30, 2020 and Patent Application No. 2021-162931 filed in Japan on Oct. 1, 2021, the entire contents of which are hereby incorporated by reference.

### TECHNICAL FIELD

The present invention relates to a technique for teaching an action to a robot.

### BACKGROUND ART

There has been known a technique for teaching an action to a robot. For example, Patent Literature 1 discloses one example of a technique that is called a direct teaching method. According to the direct teaching method, a teacher applies a force to a force sensor provided to a main body of the robot. Based on an output value from the force sensor, a calculation section gives a movement command to a driving section configured to drive a robot hand part. With this, the calculation section guides the robot hand part so that the robot hand part is put into a position and a posture desired by the teacher. The calculation section causes a storage section to store the position and posture therein. In order to prevent the robot from conducting an excessive action against the teacher's intention, when the output value from the force sensor is outside a certain range, the calculation section gives a zero movement amount command to the driving section.

### CITATION LIST

### Patent Literature

[Patent Literature 1] Japanese Patent Application Publication Tokukaihei No.

02-9553 (1990)

### SUMMARY OF INVENTION

### Technical Problem

With the technique disclosed in Patent Literature 1, even when the output value from the force sensor is within the certain range, the robot hand part may possibly conduct an excessive action against the teacher's intention, due to an unexpected factor or the like. In this case, it is impossible to secure sufficient safety of the teacher who is in the vicinity of the robot, disadvantageously. Meanwhile, with a remote teaching method or the like that can secure the safety of the teacher, intuitive teaching as is done by the direct teaching method is impossible. If the teacher cannot carry out teaching intuitively, the teaching may be insufficient in accuracy in some cases.

An aspect of the present invention was made in order to solve the above problems, and has an object to provide a technique for teaching an action to a robot with higher accuracy.

### Solution to Problem

In order to attain the object, a control device in accordance with one aspect of the present invention is a control device for controlling a robot, the control device including one or more processors. The one or more processors execute a moving process and a generation process. A control method in accordance with one aspect of the present invention is a control method for causing one or more processors to control a robot, the control method including a moving step and a generation step.

The robot includes an arm part, a force sensor, and an end effector fixed to the arm part via the force sensor. In the moving process (moving step), the one or more processors cause the end effector to move. In the generation process (generation step), the one or more processors generate teaching information corresponding to a travel route of the end effector with reference to a detection value from the force sensor.

### Advantageous Effects of Invention

In accordance with one aspect of the present invention, it is possible to teach an action to a robot with higher accuracy.

### BRIEF DESCRIPTION OF DRAWINGS

FIG. 1 is a view schematically illustrating a configuration of a robot control system in accordance with Embodiment 1 of the present invention.

FIG. 2 is a block diagram illustrating the configuration of the robot control system in accordance with Embodiment 1 of the present invention.

FIG. 3 is a view schematically illustrating a specific example of a detection value from a force sensor and a connection mode thereof in Embodiment 1 of the present invention.

FIG. 4 is a flowchart indicating a flow of a control method in accordance with Embodiment 1 of the present invention.

FIG. 5 is a view showing a specific example of a screen displayed on a display in Embodiment 1 of the present invention.

FIG. 6 is a flowchart indicating a flow of another control method in accordance with Embodiment 1 of the present invention.

FIG. 7 is a view schematically illustrating a configuration of a robot control system in accordance with Embodiment 2 of the present invention.

FIG. 8 is a flowchart indicating a flow of a control method in accordance with Embodiment 2 of the present invention.

### DESCRIPTION OF EMBODIMENTS

### Embodiment 1

The following description will discuss details of a robot control system 1 in accordance with Embodiment 1.

<Summary of Robot Control System 1>

The robot control system 1 is a system for controlling a robot, and is configured to control the robot in accordance with a manipulation of a teacher. The robot to be controlled includes an arm part, a force sensor, and an end effector fixed to the arm part via the force sensor. One or more processors cause the end effector to move in accordance with a manipulation of the teacher with respect to a manipulation device. While the end effector is moving, the one or more processors output, to an output device, information indicative of a detection value from the force sensor on a real-time basis.

With the robot control system 1 configured as above, the teacher can manipulate the manipulation device at a place sufficiently distant from the robot (e.g., at a place outside a safety fence). This can enhance the safety of the teacher. In addition, the teacher can check the detection value from the force sensor on a real-time basis. Thus, the teacher can carry out a manipulation for causing the end effector to move, while checking an external force applied to the end effector. Consequently, the teacher can teach an action of the end effector more easily in a safer environment.

The following description deals with an example in which a hand part is employed as the end effector of Embodiment 1.

<Configuration of Robot Control System 1>

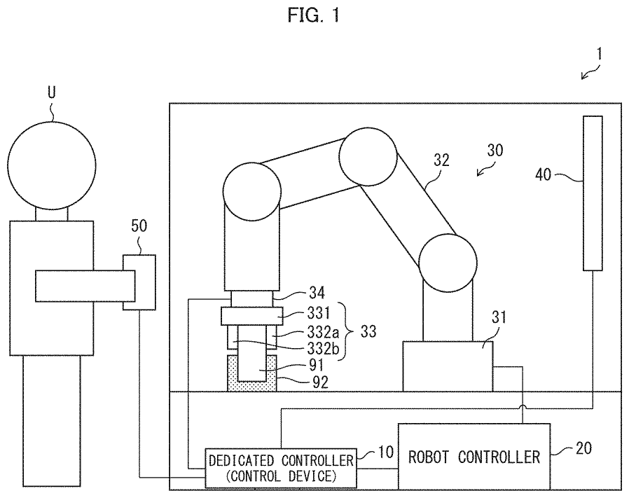

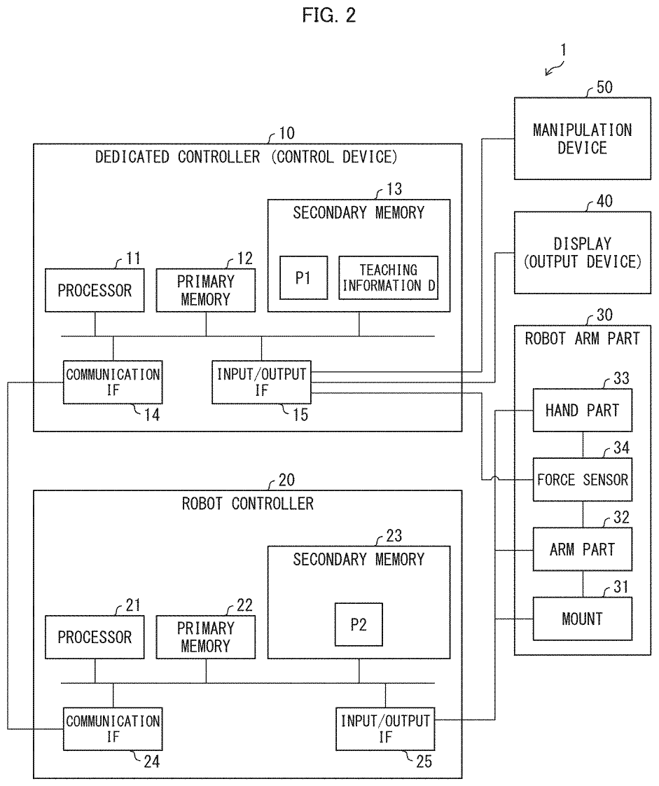

With reference to FIGS. 1 and 2, the following will describe a configuration of the robot control system 1. FIG. 1 is a view schematically illustrating the configuration of the robot control system 1. FIG. 2 is a block diagram illustrating the configuration of the robot control system 1.

As shown in FIGS. 1 and 2, the robot control system 1 includes a dedicated controller 10, a robot controller 20, a robot 30, a display 40, and a manipulation device 50. Here, the dedicated controller 10 is one example of the control device in accordance with the present invention. The display 40 is one example of the output device in accordance with the present invention. The robot control system 1 is a system configured to teach, to the robot 30, an action of inserting a protruded workpiece 91 into a recessed workpiece 92.

Here, the display 40 is disposed in such a manner as to allow a teacher U to visually see the display 40. The manipulation device 50 is disposed at a place distant from the robot 30 by a certain distance or more (e.g., at a place outside a safety fence). With this, the teacher U can remotely teach an action to the robot 30 while visually observing the display 40.

The protruded workpiece 91 has a protrusion that can be inserted into a recess of the recessed workpiece 92. In Embodiment 1, the protrusion has a shape that allows the protrusion to be inserted into the recess. For example, in a case where the recessed workpiece 92 is placed such that the recess faces upward, the protruded workpiece 91 may be moved downward with the protrusion faces downward. Consequently, the protrusion can be fitted into the recess. Hereinafter, moving the protruded workpiece 91 so that the protrusion of the protruded workpiece 91 is fitted into the recess of the recessed workpiece 92 may alternatively be described as inserting the protruded workpiece 91 into the recessed workpiece 92. In addition, a direction in which the protruded workpiece 91 is moved so as to be inserted into the recessed workpiece 92 may alternatively be described as an insertion direction.

The robot 30 includes a mount 31, the arm part 32, the hand part 33, and the force sensor 34.

The mount 31 is disposed on an installation surface for the robot 30. The installation surface may be a floor, for example. However, this is not limitative. The mount 31 may be configured to be movable over the installation surface under control of the robot controller 20.

The arm part 32 includes four arms. Each of the arms has a base end part coupled to a distal end part of another one of the arms or to the mount 31 in such a manner as to allow the arm to rotate about a certain axis. The arms are controlled by the robot controller 20 at the coupling parts such that the arms are rotated. In this manner, a trajectory of the distal end part of the entire arm part 32 is controlled.

The hand part 33 is fixed to the arm part 32 via the force sensor 34. The hand part 33 includes a base part 331 and a pair of finger parts 332a and 332b connected to the base part 331. Under control of the robot controller 20, the hand part 33 conducts an opening action of separating the finger parts 332a and 332b from each other and a closing action of causing the finger parts 332a and 332b to get close to each other. The hand part 33 opens and closes the finger parts 332a and 332b to hold the protruded workpiece 91. Hereinafter, opening and closing the finger parts 332a and 332b may alternatively be expressed as opening and closing the hand part 33.

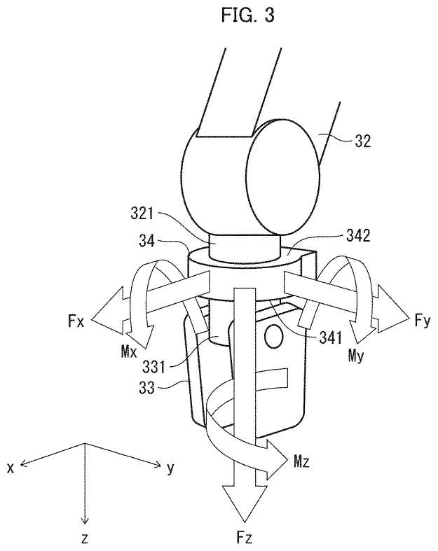

The force sensor 34 is configured to detect the direction and magnitude of a force and a moment applied to the force sensor 34. A detection value from the force sensor 34 will be explained with reference to FIG. 3. FIG. 3 is a view schematically illustrating a specific example of a detection value from the force sensor 34 and a connection mode thereof. As shown in FIG. 3, the force sensor 34 is a six-axis force sensor configured to detect (i) magnitudes (Fx, Fy, Fz) of forces acting in directions of three axes (x-axis, y-axis, z-axis) and (ii) magnitudes (Mx, My, Mz) of moments about these axes. Hereinafter, Fx, Fy, Fz, Mx, My, and Mz will be referred to as force components or simply as detection values.

As shown in FIG. 3, the force sensor 34 has a surface 341 and a surface 342. The force sensor 34 further includes a strain element (not illustrated) via which a member having the surface 341 and a member having the surface 342 are coupled to each other. The force sensor 34 detects deformation of the strain element disposed inside the force sensor 34 so as to calculate values of the components of the force applied to the force sensor 34.

With reference to FIG. 3, the following will describe one example of the connection mode in which “the hand part 33 is fixed to the arm part 32 via the force sensor 34”. As shown in FIG. 3, the distal end part 321 of the entire arm part 32 is fixed to the surface 342 of the force sensor 34. The base part 331 of the hand part 33 is fixed to the surface 341 of the force sensor 34. With this, when an external force is applied to the protruded workpiece 91 while the hand part 33 is holding the protruded workpiece 91, the external force is applied also to the force sensor 34. Thus, when an external force is applied to the protruded workpiece 91, the force sensor 34 detects the values of the components of the force applied to the force sensor 34.

The robot controller 20 is a device configured to control an action of the entire robot 30. As shown in FIG. 2, the robot controller 20 includes a processor 21, a primary memory 22, a secondary memory 23, a communication interface (IF) 24, and an input-output interface (IF) 25. The processor 21, the primary memory 22, the secondary memory 23, the communication interface 24, and the input-output interface 25 are connected to each other via a bus.

The secondary memory 23 stores a program P2 therein. The program P2 is a program configured to cause the processor 21 to execute a process for controlling an action of the entire robot 30. In accordance with an instruction included in the program P2, the processor 21 executes a process for controlling an action of the entire robot 30. The process for controlling an action of the entire robot 30 will be described in detail later.

A device that can be used as the processor 21 may be, for example, a central processing unit (CPU), a graphic processing unit (GPU), or a combination of them.

A device that can be used as the primary memory 22 may be, for example, a semiconductor random access memory (RAM). A device that can be used as the secondary memory 23 may be, for example, a flash memory, a hard disk drive (HDD), a solid state drive (SSD), or a combination of any of them.

The communication interface 24 is an interface used to communicate with the dedicated controller 10. Specific examples of the communication interface 24 encompass interfaces such as a universal serial bus (USB), Ethernet (registered trademark), Wi-Fi (registered trademark), and a serial communication system. Specific examples of a network system via which the communication interface 24 and a communication interface 14 (described later) are connected to each other encompass a local area network (LAN), a wide area network (WAN), and an internetwork including any of these networks. The dedicated controller 10 may be connected to the input-output interface 25.

The input-output interface 25 is connected with the arm part 32 and the hand part 33 via their respective driving sections (not illustrated). Examples of the input-output interface 25 encompass interfaces such as serial communication, Ethernet, DeviceNet, CC-Link, PROFIBUS, EtherNet/IP, and Ethernet for Control Automation Technology (EtherCat). One of or both the arm part 32 and the hand part 33 may be connected to the communication interface 24 via the driving section(s).

The process carried out by the robot controller 20 to control an action of the entire robot 30 includes a movement control process and a holding control process. The movement control process is a process for causing the distal end part 321 of the entire arm part 32 to move. When the distal end part 321 moves, the hand part 33, which is fixed to the distal end part 321 via the force sensor 34, also moves. Hereinafter, moving the distal end part 321 may alternatively be expressed as moving the hand part 33. The processor 21 transmits control information to driving sections respectively configured to drive the coupling parts of the arm part 32, so as to cause the hand part 33 to move. The processor 21 may cause the hand part 33 to move to a position indicated by information externally received. Alternatively, the processor may cause the hand part 33 to move in a direction indicated by information externally received.

The holding control process is a process for causing the hand part 33 to hold the protruded workpiece 91. In order to carry out the holding control process, the processor 21 carries out a raising and lowering process for raising and lowering the distal end part 321 of the arm part 32 and the opening and closing process for opening and closing the hand part 33 in combination. The processor 21 transmits control information to the driving sections respectively configured to drive the coupling parts of the arm part 32, so as to carry out the raising and lowering process. The processor 21 transmits control information to driving sections respectively configured to drive the finger parts 332a and 332b, so as to carry out the opening and closing process.

The dedicated controller 10 is a device for executing various processes for teaching an action to the robot 30. The dedicated controller 10 causes the hand part 33 to move in accordance with a manipulation of the teacher U with respect to the manipulation device 50. While the hand part 33 is moving, the dedicated controller 10 causes the display 40 to display information indicative of detection values from the force sensor 34 on a real-time basis.

As shown in FIG. 2, the dedicated controller 10 includes a processor 11, a primary memory 12, a secondary memory 13, a communication interface 14, and an input-output interface 15. The processor 11, the primary memory 12, the secondary memory 13, the communication interface 14, and the input-output interface 15 are connected to each other via a bus.

In the secondary memory 13, a program P1 and teaching information D are stored. The program P1 is a program configured to cause the processor 11 to execute a control method S1 and a control method S2, each of which will be described later. In accordance with an instruction included in the program P1, the processor 11 executes the control method S1 and the control method S2. The teaching information D is information that is to be referred to by the processor 11, which is configured to execute the control method S1 and the control method S2. The teaching information D will be described in detail later.

A device that can be used as the processor 11 may be, for example, a central processing unit (CPU), a graphic processing unit (GPU), or a combination of them.

A device that can be used as the primary memory 12 may be, for example, a semiconductor random access memory (RAM). A device that can be used as the secondary memory 13 may be, for example, a flash memory, a hard disk drive (HDD), a solid state drive (SSD), or a combination of any of them.

The communication interface 14 is an interface used to communicate with the robot controller 20. Specific examples of the communication interface 14 encompass interfaces such as a universal serial bus (USB), Ethernet (registered trademark), Wi-Fi (registered trademark), and a serial communication system. Specific examples of the network system via which the communication interface 14 and the communication interface 24 are connected to each other are identical to those described above. The robot controller 20 may be connected to the input-output interface 15.

The input-output interface 15 is connected with the force sensor 34, the display 40, and the manipulation device 50. Examples of the input-output interface 15 encompass interfaces such as serial communication, Ethernet (registered trademark), USB, an analog-to-digital converter, and Ethernet for Control Automation Technology (EtherCat). The force sensor 34 may be connected to the communication interface 14 or the input-output interface 25.

The display 40 has a display area for displaying an image. The display 40 displays, on the display area, an image generated by the processor 11. Hereinafter, displaying an image on the display area of the display 40 may simply be referred to as displaying an image on the display 40. The image displayed on the display area may alternatively be referred to as a screen. Examples of the display 40 encompass a liquid crystal display, a plasma display, and an organic electroluminescence (EL) display.

The manipulation device 50 has a manipulation section configured to accept a manipulation of the teacher U. The manipulation of the teacher U encompasses a manipulation to give an instruction regarding a moving direction of the hand part 33. The manipulation of the teacher U also encompasses a manipulation to give an instruction to give confirmation in various processes.

For example, the manipulation section includes push buttons that can function as direction buttons for an upward direction, a downward direction, a right direction, and a left direction, for example. Each of the direction buttons can accept a manipulation to give an instruction regarding a moving direction. When any of the direction buttons is pressed, the manipulation device 50 transmits, to the dedicated controller 10, direction information indicative of a direction corresponding to the direction button thus pressed. The manipulation to give the instruction regarding the moving direction can alternatively be accepted via a device such as a joystick. In this case, when the joystick is tilted, the manipulation device 50 transmits, to the dedicated controller 10, direction information indicative of a direction corresponding to the direction toward which the joystick is tiled.

The manipulation section includes a push button that can function as a confirmation button, for example. The confirmation button can accept a manipulation to give an instruction to give confirmation in the various processes. When the confirmation button is pressed, the manipulation device 50 transmits, to the dedicated controller 10, confirmation information indicative of an instruction for giving confirmation.

The manipulation device 50 may include, as the manipulation section, a touch panel, in place of or in addition to the physical user interface such as the push buttons and/or the joystick described above. In this case, the manipulation device 50 causes the touch panel to display user interface objects that can respectively function as the above-described direction buttons, joystick, and confirmation button. Upon acceptation of a manipulation of touching any of the user interface objects, the manipulation device 50 transmits direction information or confirmation information to the dedicated controller 10.

The following description will be made assuming that the manipulation device 50 includes the direction buttons and the confirmation button.

<Control Method to be Executed by Robot Control System 1>

The robot control system 1 is configured to execute the control method S1 and the control method S2. The control method S1 is a method for teaching, to the robot 30, an action of the hand part 33. The control method S2 is a method for modifying the action taught to the hand part 33 while tentatively causing the robot 30 to perform the action.

<Flow of Control Method S1>

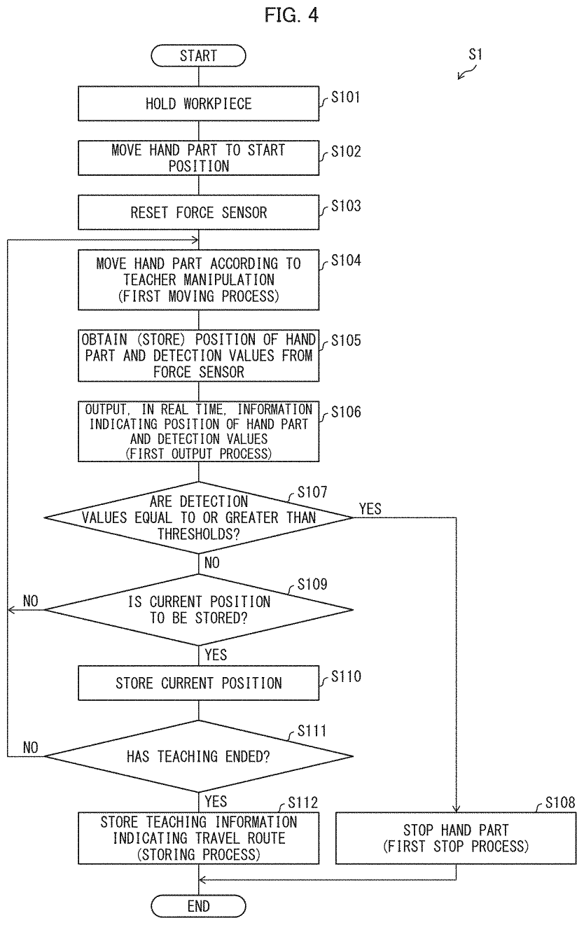

The control method S1 to be executed by the processor 11 will be described with reference to FIG. 4. FIG. 4 is a flowchart indicating a flow of the control method S1. As shown in FIG. 4, the control method S1 includes steps S101 to S112.

In step S101, the processor 11 causes the hand part 33 to hold the protruded workpiece 91. Specifically, the processor 11 requests the robot controller 20 to cause the hand part 33 to move to a holding position and then to hold the protruded workpiece 91.

More specifically, the processor 11 transmits, to the robot controller 20, information indicative of the holding position, and requests to carry out the movement control process for causing the hand part 33 to move to the holding position. The holding position is set in advance at a position above the position where the protruded workpiece 91 resides. For example, upon reception of the request to carry out the movement control process, the processor 21 of the robot controller 20 causes the hand part 33 to move to the holding position. Then, the processor 11 requests the robot controller 20 to carry out the holding control process. Upon reception of the request to carry out the holding control process, the processor 21 of the robot controller 20 opens the hand part 33 and lowers the hand part 33 to the position where the protruded workpiece 91 resides. Then, the processor 21 closes the hand part 33 so that the hand part 33 can hold the protruded workpiece 91, and then raises the hand part 33 to the original holding position.

In this step, the hand part 33 holds the protruded workpiece 91 with the protruded workpiece 91 oriented so that the protruded workpiece 91 can be inserted into the recessed workpiece 92. As shown in FIG. 1, in a case where the recessed workpiece 92 is placed such that the recess of the recessed workpiece 92 faces upward, the orientation with which the protruded workpiece 91 can be inserted into the recessed workpiece 92 is an orientation with which the protrusion of the protruded workpiece 91 faces downward. For example, before the protruded workpiece 91 is held, the protruded workpiece 91 may be placed such that its protrusion faces downward. This makes it possible for the hand part 33 to hold the protruded workpiece 91 with the protruded workpiece 91 oriented so that the protruded workpiece 91 can be inserted into the recessed workpiece 92.

In step S102, the processor 11 causes the hand part 33 to move to a start position. Here, the start position refers to a position where teaching is to be started. The start position may be defined in advance in some cases, and may be designated by the teacher U in other cases.

The following will describe the case where the start position is defined in advance. In this case, as the start position, a position above the recessed workpiece 92 is defined in advance. The processor 11 requests the robot controller 20 to cause the hand part 33 to move to the start position. More specifically, the processor 11 transmits, to the robot controller 20, information indicative of the start position, and requests to carry out the movement control process for causing the hand part 33 to move to the start position. Upon reception of the request to carry out the movement control process, the processor 21 of the robot controller 20 causes the hand part 33 to move to the start position.

The following will describe the case where the start position is designated by the teacher U. In this case, the teacher U manipulates any of the direction buttons of the manipulation device 50 so as to cause the hand part 33 to move to a desired start position. The processor 11 transmits, to the robot controller 20, direction information received from the manipulation device 50, and requests the movement control process. Upon reception of the request to carry out the movement control process, the processor 21 of the robot controller 20 causes the hand part 33 to move in a direction indicated by the direction information. When the hand part moves to the desired start position, the teacher U operates the confirmation button of the manipulation device 50. Upon reception of the confirmation information from the manipulation device 50, the processor 11 defines, as the start position, the position of the hand part 33 at that time. The processor 11 causes the primary memory 12 to store the information indicative of the start position as the information indicative of the first transit point in the travel route.

In step S103, the processor 11 resets the force sensor 34. Just after the force sensor 34 was reset, the force sensor 34 outputs zero as each of the detection values.

In step S104, the processor 11 executes a moving process for causing the hand part 33 to move. Specifically, in accordance with a manipulation of the teacher U with respect to the manipulation device 50 (e.g., pressing of any of the direction buttons), the processor 11 requests the robot controller 20 to cause the hand part 33 to move. The process carried out in this step is one example of the first moving process in accordance with the present invention. More specifically, the processor 11 transmits, to the robot controller 20, the direction information received from the manipulation device 50, and requests to carry out the movement control process for causing the hand part 33 to move in a moving direction indicated by the direction information. Upon reception of the request to carry out the movement control process, the processor 21 of the robot controller 20 causes the hand part 33 to move in the direction indicated by the direction information. This step will be repeatedly carried out after the detection values from the force sensor 34 are displayed on the display 40 in step S106 (described later). With this, while visually observing, on a real-time basis, the detection values displayed on the display 40, the teacher U can manipulate the manipulation device 50 so as to cause the hand part 33 to move. The manipulation of the teacher U will be described in detail later.

In step S105, the processor 11 obtains the detection values from the force sensor 34. Here, in a case where the protruded workpiece 91 is moving in an appropriate insertion direction with respect to the recessed workpiece 92, no external force is applied to the protruded workpiece 91. In this case, each of the detection values from the force sensor 34 is zero. In a case where the protruded workpiece 91 is moving in a direction deviated from the appropriate insertion direction, an external force from the recessed workpiece 92 is applied to the protruded workpiece 91. In this case, at least any of the detection values from the force sensor 34 is greater than zero.

In step S105, the processor 11 obtains information indicative of the position of the hand part 33. In a case where the orientation of the hand part 33 is variable, the processor 11 may further obtain information indicative of the orientation of the hand part 33.

In step S106, the processor 11 causes the display 40 to display, on a real-time basis, the information indicative of the position of the hand part 33 and the information indicative of the detection values from the force sensor 34. In a case where the orientation of the hand part 33 is variable, the processor 11 may cause the display 40 to further display, on a real-time basis, the information indicative of the orientation of the hand part 33. The process carried out in this step is one example of the first output process in accordance with the present invention.

Specifically, the processor 11 causes the display 40 to display, on a real-time basis, an image indicative of a virtual space in which an object corresponding to the hand part 33 is disposed, the information indicative of the position of the hand part 33, and the information indicative of the detection values. In the virtual space, the object corresponding to the hand part 33 is disposed at a virtual position corresponding to the real position of the hand part 33. The information indicative of the detection values indicates detection values obtained when the hand part 33 is at that real position. An exemplary screen displayed on the display 40 in this step will be described later.

In step S107, the processor 11 determines whether or not the detection values from the force sensor 34 satisfy a certain condition. Here, the certain condition is that at least any of the detection values exceeds a threshold. The thresholds are respectively defined for the detection values Fx, Fy, Fz, Mx, My, and Mz, which are obtained by the force sensor 34.

Among the thresholds of the detection values, the threshold of the detection value Fz is defined so as to be greater than any other one of the thresholds of the detection values. The reason for this is as follows. That is, when the protruded workpiece 91 is inserted and reaches an appropriate position, the tip of the protrusion reaches the recessed workpiece 92, and an external force is applied to the protruded workpiece 91 only in the z-axis direction.

If the processor 11 determines Yes in step S107, the processor 11 requests, in step S108, the robot controller 20 to stop the hand part 33. The process carried out in this step is one example of the first stop process in accordance with the present invention. Upon reception of the request for stop, the processor 21 of the robot controller 20 causes the hand part 33 to stop moving. Then, the processor 11 ends the control method S1.

By executing this step, the dedicated controller 10 can reduce the possibility that, during teaching, the robot 30 may carry out an action with which the detection values from the force sensor 34 satisfy the certain condition (i.e., at least any of the detection values exceeds the threshold). For example, a certain condition (thresholds) with which detection values obtained when the robot 30 carried out an excessive action can be determined may be set. With this, it is possible to reduce the risk that a subject to be worked by the robot 30 or a facility in the vicinity of the robot 30 may be broken.

If the processor 11 determines No in step S107, the processor 11 determines, in step S109, whether to store the current position of the hand part 33 as a transit point in a travel route. For example, the processor 11 may make this determination in accordance with a manipulation of the teacher U with respect to the manipulation device 50 (e.g., pressing of the confirmation button). In this case, for example, if the processor 11 receives confirmation information from the manipulation device 50, the processor 11 determines to store the current position of the hand part 33 as the transit point.

If the processor 11 determines No in step S109, the processor 11 carries out the processes from step S104 again.

If the processor 11 determines Yes in step S109, the processor 11 obtains, in step S110, information indicative of the current position of the hand part 33. The position of the hand part 33 is indicated by, e.g., space coordinates using the start position as the origin. For example, the processor 11 may calculate the current position of the hand part 33 based on the moving direction of the hand part 33 and a history of a moved length. The processor 11 causes the primary memory 12 to store the information indicative of the current position of the hand part 33 as information indicative of the transit point.

In step S111, the processor 11 determines whether or not the teaching has been ended. For example, the processor may make this determination in accordance with a manipulation of the teacher U with respect to the manipulation device 50 (e.g., pressing of the confirmation button). In this case, for example, if the processor 11 receives confirmation information from the manipulation device 50, the processor 11 determines that the teaching has been ended.

Alternatively, for example, the processor 11 may make the determination of whether or not the teaching has been ended, on the basis of the detection values from the force sensor 34. For example, when the protruded workpiece 91 is inserted and reach an appropriate position, an external force is applied to the protruded workpiece 91 only in the z-axis direction and only the detection value Fz becomes greater, as described above. Thus, the processor 11 may employ, as the condition for ending the teaching, the condition that the detection value Fz exceeds a certain value and the other detection values are zero.

If the processor 11 determines No in step S111, the processor 11 carries out the processes from step S104 again.

If the processor 11 determines Yes in step S111, the processor 11 causes, in step S112, the secondary memory 13 to store teaching information D indicative of the travel route of the hand part 33. This step is one example of the storing process in accordance with the present invention. Then, the processor 11 ends the control method S1.

Here, the teaching information D is information indicative of the travel route of the hand part 33 in the first moving process (step S104). For example, the processor 11 causes the primary memory 12 to store, as information indicative of the last transit point in the travel route, information indicative of the position of the hand part 33 at the time when it is determined that the teaching has been ended (hereinafter, such a position may also be referred to as a terminal position). The processor 11 deals with, as the teaching information D, an array of pieces of information that are indicative of the transit points stored in the primary memory 12 and that are arranged in the order in which the hand part 33 has passed. In other words, the teaching information D is an array of the pieces of information indicative of the transit points arranged in an order along the travel route. As stated above, the teaching information D is generated in a case where no output value exceeds the threshold when referring to the output values from the force sensor 34 (No in step S107). Therefore, the process for generating such teaching information D is one example of the “generation process for generating, with reference to a detection value from the force sensor, teaching information corresponding to a travel route of the end effector” of the present invention.

<Example of Screen>

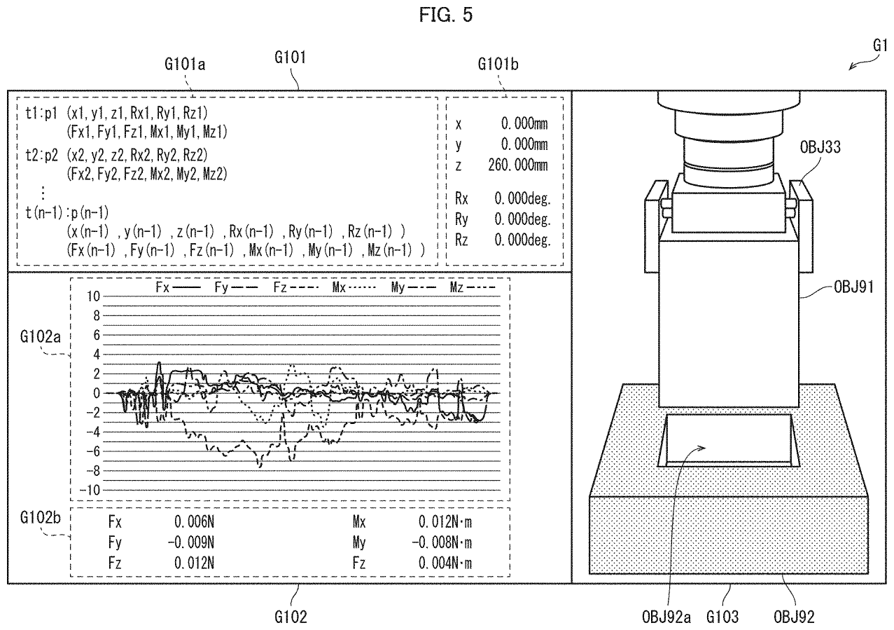

Next, with reference to FIG. 5, the following will explain a specific example of a screen employed in the control method S1. FIG. 5 shows one example of a screen (screen G1) displayed on the display 40. Here, the screen G1 is one example of a screen to be output in an nth process (n is an integer equal to or higher than 2) among the processes repeatedly carried out in the control method S1. Hereinafter, a time point when an ith process (i=1, 2, 3, . . . , n) among the processes repeatedly carried out is executed may also be referred to as a time point i. As shown in FIG. 5, the screen G1 includes areas G101, G102, and G103.

The area G101 includes areas G101a and G101b. The area G101a is an area for displaying, on a real-time basis, a history of information related to the position of the hand part 33. The area G101b is an area for displaying, on a real-time basis, information related to the current position of the hand part 33.

Specifically, the area G101a includes pieces of information indicative of the positions of the hand part 33 from the start position p1 to the latest position p(n−1). Note that the latest position p(n−1) refers to the position of the hand part 33 at a time point t(n−1). In this example, the area G101a displays information related to a position pi of the hand part 33 and information indicative of detection values obtained by the force sensor 34 at a time point ti (i=1, 2, 3, . . . , n−1). Specifically, as the information related to the position pi, values indicative of xi, yi, zi, Rxi, Ryi, and Rzi are displayed. (xi, yi, zi) indicates the position pi. (Rxi, Ryi, Rzi) indicates an orientation of the hand part 33 at the position pi. As the information indicative of the detection values obtained by the force sensor 34 at the time point ti, values of Fxi, Fyi, Fzi, Mxi, Myi, and Mzi are displayed.

The area G101b includes information related to the current position pn of the hand part 33 at the current time point tn. Specifically, (x, y, z) included in the area G101b indicates the current position pn. (Rx, Ry, Rz) included in the area G101b indicates an orientation of the hand part 33 at the current position pn.

The area G102 is an area for displaying, on a real-time basis, pieces of information indicative of detection values from the force sensor 34. Specifically, the area G102 includes an area G102a and an area G102b. The area G102a displays a graph showing changes over time in detection values observed until the current time point tn. The area G102b displays detection values obtained by the force sensor at the current time point tn. Thus, the area G102 includes information indicative of the detection values obtained by the force sensor 34 at the time when the hand part 33 is at the current position pn. In step S106, the processor 11 updates the areas G102a and G102b with use of the detection values obtained at the current time point tn.

The area G103 is an area for displaying, on a real-time basis, an image indicative of a virtual space in which an object OBJ33 is disposed. The object OBJ33 is an object corresponding to the hand part 33. In the virtual space, the object OBJ33 is disposed at a virtual position corresponding to the real current position pn of the hand part 33. In the virtual space, objects OBJ91 and OBJ92 respectively corresponding to the protruded workpiece 91 and the recessed workpiece 92 are disposed at virtual positions corresponding to the real positions. The object OBJ92 has a recess OBJ92a corresponding to the recess of the recessed workpiece 92. The recess OBJ92a has a shape with which the recess OBJ92a is in close contact with the tip of the object OBJ91 when the object OBJ91 enters the recess OBJ92a. For example, the processor 11 generates a visual-field image of the object OBJ33 (or OBJ91 or OBJ92) viewed from a virtual viewpoint in the virtual space, and displays the visual-field image thus generated on the area G103. When the real positions of the hand part 33 and the protruded workpiece 91 move, the processor 11 causes the virtual positions of the objects OBJ33 and OBJ91 to move in the virtual space to update the visual-field image. Note that the virtual viewpoint refers to the position of the viewpoint in the virtual space. The virtual viewpoint may be a virtual position defined in advance or a virtual position corresponding to the real position of the manipulation device 50 or the like. The virtual viewpoint may be changeable in accordance with a manipulation of the teacher U.

<Flow of Manipulations by Teacher U>

With use of the robot control system 1 configured to execute the control method S1, the teacher U can carry out a manipulation for teaching an action to the robot 30, while seeing the screen G1 displayed on the display 40 at a location outside the safety fence. After the hand part 33 holding the protruded workpiece 91 has moved to the start position (i.e., after the processor 11 has executed steps S101 to S103), the teacher U carries out manipulations in the following steps A1 to A5.

In step A1, while visually observing the screen G1, the teacher U manipulates any of the direction buttons of the manipulation device 50 to cause the hand part 33 to move. Consequently, the processor 11 executes steps S104 to S107.

Here, if the moving direction of the protruded workpiece 91 is deviated from an appropriate insertion direction with respect to the recessed workpiece 92, an external force is applied to the protruded workpiece 91. Consequently, at least any of the detection values from the force sensor 34 exceeds zero, and a detection value(s) greater than zero is/are displayed on the area G102. In this case, by seeing the areas G101 and G103, the teacher U can recognize the position of the hand part 33 at which position an external force is applied to the protruded workpiece 91. With this, the teacher U can recognize deviation of the moving direction of the hand part 33 from the appropriate insertion direction. Then, the teacher U carries out a manipulation for causing the hand part 33 to make the detection value zero so that the moving direction coincides with the appropriate insertion direction.

In step A2, the teacher U manipulates the confirmation button of the manipulation device 50 so that the current position of the hand part 33 is set as a transit point. In response to this, the processor 11 executes the processes from steps S109 and S110, and adds information indicative of the transit point to the primary memory 12 so that the information is stored therein.

In step A3, the teacher U carries out steps A1 and A2 repeatedly.

In step A4, the teacher U recognizes, in the area G101, that only the detection value Fz has exceeded zero and the other detection values are zero. As described above, the state in which only the detection value Fz is greater than zero means the state in which the tip of the protrusion of the protruded workpiece 91 has reached the recessed workpiece 92, i.e., the state in which the tip of the protrusion of the protruded workpiece 91 has reached an appropriate insertion position.

In step A5, the teacher U manipulates the confirmation button of the manipulation device 50 to end the teaching. In response to this, the processor 11 executes steps S111 and S112. Consequently, an array of pieces of information indicative of two or more transit points from the start position to the terminal position is stored in the secondary memory 13 as teaching information D.

For example, assume that the hand part 33 has moved from a position p1 to a position pN (N is an integer equal to or greater than n) during a period from a start time point t 1 to an end time point tN, at which teaching is ended. Assume also that M among N positions pi are stored as transit points Pj (j=1, 2, . . . , M; M is an integer equal to or greater than 2; P1=p1; PM=pN). In this case, the teaching information D is an array in which pieces of information indicating transit points P1, P2, . . . , and PM are arranged in this order. That is, the teaching information D indicates the travel route along which the hand part 33 passes through the transit points P1, P2, . . . , and PM in this order.

Thus, the teacher U can carry out teaching more easily. The reason for this is as follows. That is, the teacher U can visually observe the above-described image in the virtual space and the above-described information indicative of the detection values at the same time, and thus can recognize the position of the hand part 33 and the detection values from the force sensor 34 in association with each other. With this, the teacher U can easily find the position of the hand part 33 at which position appropriate detection values can be obtained by the force sensor 34. This improves ease in teaching.

In addition, in the process for remotely teaching an action to the robot 30 with use of the manipulation device 50, the teacher U can confirm, on the screen G1, a relation between the external force applied to the protruded workpiece 91 and the position of the hand part 33. Thus, the teacher U can easily teach an action even remotely.

<Flow of Control Method S2>

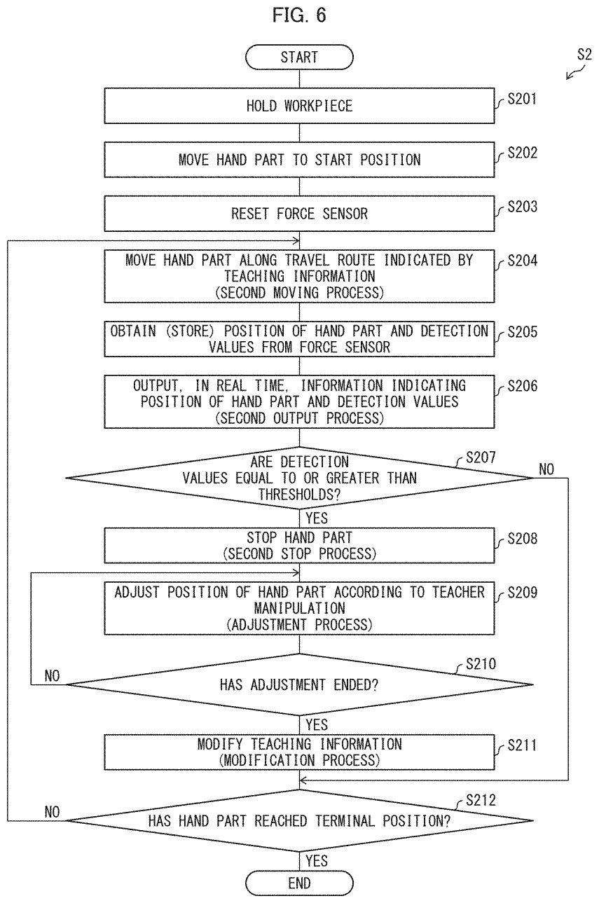

The control method S2 to be executed by the processor 11 will be described with reference to FIG. 6. As described above, the control method S2 is a method for modifying the action taught to the hand part 33 while tentatively causing the robot 30 to perform the action. FIG. 6 is a flowchart indicating a flow of the control method S2. As shown in FIG. 6, the control method S2 includes steps S201 to S212.

Operation of the processor 11 in steps S201 to S203 is identical to the operation in steps S101 to S103. Thus, the processor 11 causes the hand part 33 to hold the protruded workpiece 91 and to move to the start position, and resets the force sensor 34.

Next, the processor 11 reads the teaching information D from the secondary memory 13, and causes the hand part 33 to move along a travel route indicated by the teaching information D thus read (S204). The process carried out in this step is one example of the second moving process in accordance with the present invention. More specifically, with reference to the teaching information D, the processor 11 obtains information indicative of the first transit point in the travel route. The processor 11 transmits the information indicative of the transit point to the robot controller 20, and requests a movement control process. Upon reception of the request to carry out the movement control process, the processor 21 of the robot controller 20 causes the hand part 33 to move to the transit point. Then, the processor 11 obtains information indicative of a next transit point in the travel route and transmits the information to the robot controller 20. The processor 11 repeats this process. Consequently, the hand part 33 moves along the travel route indicated by the teaching information D.

In step S205, the processor 11 obtains detection values from the force sensor 34. Here, in a case where the protruded workpiece 91 is moving in an appropriate insertion direction, no external force is applied to the protruded workpiece 91. In this case, each of the detection values from the force sensor 34 is zero. In a case where the protruded workpiece 91 is moving in a direction deviated from the appropriate insertion direction, an external force from the recessed workpiece 92 is applied to the protruded workpiece 91. In this case, at least any of the detection values from the force sensor 34 is greater than zero.

In step S205, the processor 11 also obtains information indicative of the position of the hand part 33. In a case where the orientation of the hand part 33 is variable, the processor 11 may further obtain information indicative of the orientation of the hand part 33.

In step S206, the processor 11 causes the display 40 to display, on a real-time basis, the information indicative of the position of the hand part 33 and the information indicative of the detection values from the force sensor 34.

In a case where the orientation of the hand part 33 is variable, the processor 11 may further display, on a real-time basis, the information indicative of the orientation of the hand part 33. The processes in steps S205 and S206 are repeatedly executed during an adjustment process, which is carried out in step S209 (described later). The process carried out in this step is one example of the second output process in accordance with the present invention.

Specifically, in a similar manner to the first output process, the processor 11 causes the display 40 to display, on a real-time basis, an image indicative of a virtual space in which an object corresponding to the hand part 33 is disposed, the information indicative of the position of the hand part 33, and the information indicative of the detection values. In the virtual space, the object is disposed at a virtual position corresponding to the real current position of the hand part 33. The information indicative of the detection values indicates detection values obtained when the hand part 33 is at the real current position. An exemplary screen indicated on the display 40 in this step is identical to that described with reference to FIG. 5.

In step S207, the processor 11 determines whether or not the detection values from the force sensor 34 satisfy a certain condition. Here, the certain condition is that at least any of the detection values is equal to or greater than a threshold. The details of the process carried out in this step are the same as those described for step S107.

If the processor 11 determines No in step S207, the processor 11 executes a process in the step S212, which will be described later.

If the processor 11 determines Yes in step S207, the processor 11 requests the robot controller 20 to stop the hand part 33 in step S208. The process carried out in this step is one example of the second stop process in accordance with the present invention. Upon reception of the request for stopping, the processor 21 of the robot controller 20 causes the hand part 33 to stop moving. In this case, for example, the processor 11 may cause the display 40 to display information indicative of the current position of the hand part 33 as a part to be modified.

In step S210, in accordance with a manipulation of the teacher U with respect to the manipulation device 50 (e.g., pressing of any of the direction buttons), the processor 11 adjusts the position of the hand part 33 at which position the hand part 33 has stopped moving as a result of the second stop process. The process carried out in this step is one example of the adjustment process in accordance with the present invention.

More specifically, the processor 11 transmits, to the robot controller 20, the direction information received from the manipulation device 50, and requests to carry out the movement control process for causing the hand part 33 to move in a moving direction indicated by the direction information. Upon reception of the request to carry out the movement control process, the processor 21 of the robot controller 20 causes the hand part 33 to move in the moving direction. Here, as described above, during execution of this step, the processes in steps S205 and S206 are repeatedly executed. That is, the display 40 displays, on a real-time basis, information indicative of the detection values that can be changed by the adjustment process. With this, the teacher U can carry out the manipulation for adjusting the position of the hand part 33 while visually observing the detection values displayed on the display 40 on a real-time basis. The manipulation of the teacher U will be described in detail later.

In step S210, the processor 11 determines whether or not the adjustment has been ended. For example, the processor 11 may make this determination in accordance with a manipulation of the teacher U with respect to the manipulation device 50 (e.g., pressing of the confirmation button). In this case, if the processor 11 receives the confirmation information from the manipulation device 50, the processor 11 determines that the adjustment has been ended.

In step S211, the processor 11 modifies the teaching information D on the basis of the position having been adjusted by the adjustment process. The process carried out in this step is one example of the modification process in accordance with the present invention.

Specifically, for example, the processor 11 obtains information indicative of the current position of the hand part 33. Then, the processor 11 modifies the teaching information D with use of the information indicative of the current position thus obtained. For example, assume that the teaching information D includes pieces of information that are indicative of M transit points Pj and that are arranged in this order. Assume also that the current position of the hand part 33 (i.e., the part to be modified) is between the transit point Pk and the transit point Pk+1. In this case, the processor 11 modifies the teaching information D such that the current position is inserted, as a new transit point, between the transit point Pk and the transit point Pk+1.

In step S212, the processor 11 determines whether or not the hand part 33 has reached the terminal position of the travel route indicated by the teaching information D.

If the processor 11 determines No in step S212, the processor 11 carries out the processes from step S204 again. If the processor 11 determines Yes in step S212, the processor 11 ends the control method S2.

<Flow of Manipulations by Teacher U>

With use of the robot control system 1 configured to execute the control method S2, the teacher U can carry out a manipulation for modifying the travel route having been taught, while seeing the screen G1 displayed on the display 40 at a location outside the safety fence. After the hand part 33 holding the protruded workpiece 91 has moved to the start position (i.e., after the processor 11 has executed steps S201 to S203), the teacher U carries out manipulations in the following steps B1 to B6.

In step B1, the teacher U visually observes the screen G1 while the robot 30 is tentatively carrying out an action in accordance with the teaching information D. That is, the processor 11 executes the processes from steps S204 to S206.

In step B2, if any of the detection values from the force sensor 34 exceeds the threshold, the hand part 33 stops. That is, the processor 11 executes the processes of steps S207 and S208. Then, by visually observing the screen G1, the teacher U recognizes the part to be modified in the travel route.

In this process, in the area G101 of the screen G1, the current position of the hand part 33 is displayed in a mode in which the current position of the hand part 33 is indicated as the part to be modified. For example, assume that the screen G1 shown in FIG. 5 is displayed on the display 40 in step B2. That is, assume that at least any of the detection values from the force sensor 34 exceeds the threshold when the hand part 33 is at the position pn. In this case, the position pn is the part to be modified in the travel route. Thus, the processor 11 displays the row of the position pn in the area G101 in the mode in which that row is indicated as the part to be modified. The mode for indicating the part to be modified may be achieved by, e.g., changing the color of a text or the color of the background of the text, indicating the text in boldface, or indicating the text by flashing. However, this is not limitative.

In step B4, while visually observing the area G102, the teacher U manipulates any of the direction buttons of the manipulation device 50 to cause the hand part 33 to move. In response to this, the processor 11 executes the process in step S209. Specifically, the teacher U adjusts the position of the hand part 33 so as to make the detection values displayed on the area G102 zero.

In step B5, when the detection values displayed on the area G102 become zero, the teacher U manipulates the confirmation button of the manipulation device 50 to end the adjustment process. In response to this, the processor 11 executes step S211. As a result, the current position of the hand part 33 at the time when the detection values become zero is inserted into the travel route as a transit point.

The teacher U repeatedly carries out steps B1 to B5. Thus, in a case where an external force is applied to the protruded workpiece 91 in a part of a tentative action carried out by the robot 30, the teacher U can modify the teaching information D.

<Effects of Embodiment 1>

With the technique disclosed in Patent Literature 1, even when the output value from the force sensor is within the certain range, the robot hand part may possibly conduct an excessive action against the teacher's intention, due to an unexpected factor or the like. In this case, it is impossible to secure sufficient safety of the teacher who is in the vicinity of the robot, disadvantageously. Meanwhile, with the remote teaching method or the like that can secure the safety of the teacher, intuitive teaching as is done by the direct teaching method is impossible. Thus, the remote teaching method or the like has a problem in ease in teaching.

Embodiment 1 can provide the technique for allowing a teacher to carry out teaching more easily while enhancing the safety of the teacher who is teaching an action to the robot, and thus can solve the above-described problem. In addition, since Embodiment 1 makes it possible for the teacher to carry out teaching more easily, the teacher can teach an action to the robot with higher accuracy.

More specifically, Embodiment 1 makes it possible for a teacher to carry out teaching more easily, while enhancing the safety of the teacher who is teaching an action to the robot. One of the reasons for this is as follows. That is, the place where the teacher manipulates the manipulation device may be distant from the robot. Another one of the reasons for this is as follows. That is, thanks to the configuration in which the detection values from the force sensor are output, the teacher can teach an action to the robot while grasping, on a real-time basis, an external force applied to the external force. This enables the teacher to carry out teaching easily, even if the teacher cannot intuitively understand the external force applied to the end effector as in the direct teaching.

Specifically, with use of the robot control system 1 in accordance with Embodiment 1 described above, the teacher U can easily teach an action to the robot 30 even while the teacher U is in a safer environment, specifically, at a place outside the safety fence. The reason for this is as follows. That is, on the screen G1, the teacher U can see the detection values from the force sensor 34 on a real-time basis. Therefore, the teacher U can grasp, on a real-time basis, an external force applied to the protruded workpiece 91. As a result, the teacher U can carry out teaching while grasping the external force on a real-time basis, even if the teacher U cannot intuitively grasp the external force applied to the protruded workpiece 91 as in the direct teaching.

Moreover, with use of the technique in accordance with Embodiment 1, the teacher U can recognize a relation between the detection values from the force sensor 34 and the position of the hand part 33 by seeing the screen G1.

This further enhances ease in teaching. For example, by carrying out a manipulation while observing the screen G1, the teacher U can easily find the position of the hand part 33 at which position the detection values from the force sensor 34 become zero. As a result, the teacher U can easily carry out teaching with respect to the robot 30 so that the hand part 33 can pass through positions where no external force is applied to the protruded workpiece 91.

Furthermore, with use of the technique in accordance with Embodiment 1, the teacher U can easily understand an appropriate position where teaching should be ended, for example. Here, if teaching of an action of inserting the protruded workpiece 91 into the recessed workpiece 92 is not ended at the appropriate position, the protruded workpiece 91 or the recessed workpiece 92 may possibly be broken. For example, in a case where a teacher U who has less experience remotely carries out teaching through visual observation without use of the technique in accordance with Embodiment 1, it is highly possible that such breakage may occur or teaching may be ended prior to the appropriate position as a result of avoidance of the breakage. Use of the technique in accordance with Embodiment 1 makes it possible even for the teacher U who has less experience to recognize that the protruded workpiece 91 has reached the appropriate position, at the point when only the detection value Fz becomes greater than zero on the screen G1. As a result, even the teacher U who has less experience can easily end the teaching at the appropriate position.

In addition, with use of the robot control system 1 in accordance with Embodiment 1 the teacher U can more easily modify the action having been taught to the robot 30. The reason for this is as follows. That is, in a case where any of the detection values from the force sensor 34 is inappropriate in a part of the action having been taught, the teacher U can modify the action having been taught while grasping an external force applied to the hand part 33 on a real-time basis. With this, even if the teacher U cannot intuitively understand the external force applied to the hand part 33 as in the direct teaching, the teacher U can easily modify the action having been taught.

More specifically, the teacher U can easily modify the travel route having been taught to the robot 30 even while the teacher U is in a safer environment, specifically, at a place outside the safety fence. The reason for this is as follows. That is, in a case where an external force is applied to the protruded workpiece 91 in a part of the travel route, the teacher U can modify that part while seeing the screen G1. For example, by carrying out a manipulation while observing the screen G1, the teacher U can easily find, in the vicinity of the position where at least any of the detection values is greater than zero, a position where the detection values are zero. As a result, the teacher U can easily modify the travel route so that the hand part 33 does not pass through the part where an external force is applied to the protruded workpiece 91.

For example, use of the technique in accordance with Embodiment 1 makes it possible even for a teacher U who has less experience to reduce the period of time taken for teaching. Here, in a case where a teacher U who has less experience remotely carries out teaching through visual observation without use of the technique in accordance with Embodiment 1, it is highly possible that the number of times to modify the travel route may be increased. In Embodiment 1, even the teacher U who has less experience cam modify the travel route while observing, on a real-time basis, an external force applied to the protruded workpiece 91 on the screen G1. Thus, it is possible to obtain a more appropriate travel route with a smaller number of times of modifications. As a result, even the teacher U who has less experience can reduce the period of time taken for teaching in total.

In addition, in accordance with Embodiment 1, if any of the detection values from the force sensor 34 becomes equal to or greater than the threshold during teaching carried out by the teacher U or a tentative action, the hand part 33 stops moving. This can reduce the possibility that the robot 30 may conduct an unexpected action. As a result, it is possible to reduce the risk that the protruded workpiece 91, the recessed workpiece 92, equipment in the vicinity thereof, or the like may be broken.

### Embodiment 2

The following description will discuss details of a robot control system 1A in accordance with Embodiment 2.

<Summary of Robot Control System 1A>

The robot control system 1 of Embodiment 1 modifies, in accordance with a manipulation by the teacher U, the teaching information D generated in accordance with a manipulation of the teacher U. The robot control system 1A of Embodiment 2 modifies teaching information D generated in accordance with a manipulation of a teacher U while outputting detection values from the force sensor 34, and does not carry out the modification of the teaching information D in accordance with a manipulation of the teacher U.

<Configuration of Robot Control System 1A>

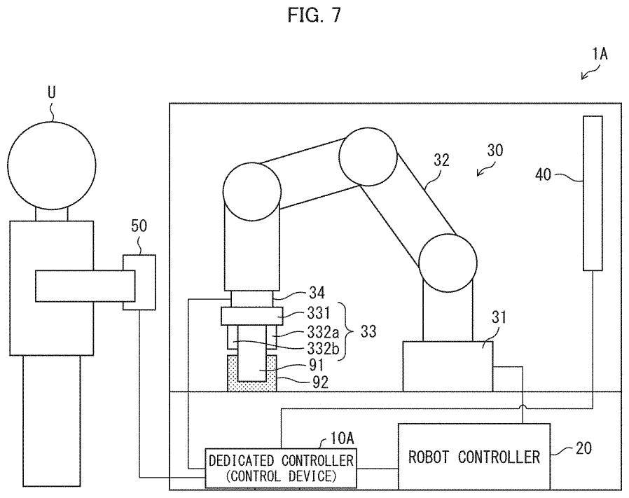

With reference to FIG. 7, the following will describe a configuration of the robot control system 1A. FIG. 7 is a view schematically illustrating the configuration of the robot control system 1A. The robot control system 1A is substantially identical in configuration to the robot control system 1 in accordance with Embodiment 1. However, the robot control system 1A differs from the robot control system 1 in that the robot control system 1A has a dedicated controller 10A in place of the dedicated controller 10. Here, the dedicated controller 10A is one example of the control device in accordance with the present invention. The details of the robot controller 20, the robot 30, the display 40, the manipulation device 50, the protruded workpiece 91, and the recessed workpiece 92 are identical to those described in Embodiment 1.

The details of the configuration of the dedicated controller 10A are substantially identical to those of the dedicated controller 10, which has been described with reference to FIG. 2. However, the details of a program P1 stored in the secondary memory 13 of the dedicated controller 10A differ from those of the dedicated controller 10. The program P1 is a program configured to cause the processor 11 to execute the control method S1 and a control method S3.

<Control Method to be Executed by Robot Control System 1A>

The robot control system 1A is configured to execute the control method S1 and the control method S3. The control method S1 is identical to that described in Embodiment 1. The control method S3 is a method in which a travel route included in teaching information D is modified not in accordance with a manipulation of the teacher U.

<Flow of Control Method S3>

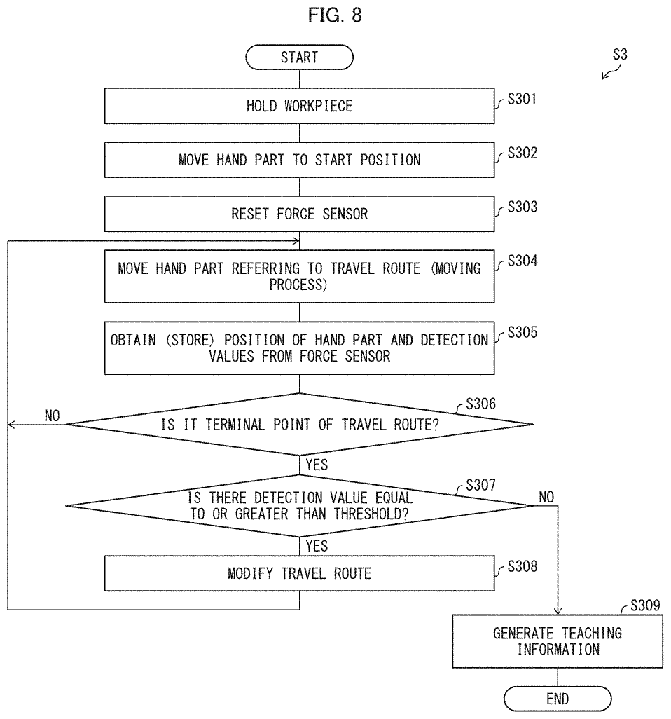

The control method S3 to be executed by the processor 11 will be described with reference to FIG. 8. FIG. 8 is a flowchart indicating a flow of the control method S3. As shown in FIG. 8, the control method S3 includes steps S301 to S309.

Operation in steps S301 to S303 is identical to the operation in steps S201 to S203 of the control method S2 having been explained with reference to FIG. 6. With this operation, the hand part 33 moves to the start position while holding the protruded workpiece 91 with the protruded workpiece 91 oriented so that the protruded workpiece 91 can be inserted into the recessed workpiece 92 (here, the orientation with which the protrusion faces downward).

Operation in step S304 is identical to the operation in step S204 in the control method S2. The operation in this step is one example of the moving process recited in the claims. With this operation, the hand part 33 moves to the first transit point or another transit point next to the first transit point included in the teaching information D. This step is repeated, as describer later. Consequently, the hand part 33 moves from the start point to the terminal point of the travel route indicated by the teaching information D.

Operation in step S305 is identical to the operation in step S205 in the control method S2. With this operation, while the hand part 33 is moving in step S304, the processor 11 obtains the detection values from the force sensor 34 and the information indicative of the position of the hand part 33, and causes the primary memory 12 to store them in association with each other. Similarly to step S205, in a case where the orientation of the hand part 33 is variable, the processor 11 may further obtain information indicative of the orientation of the hand part 33, and may cause the primary memory 12 to store the information indicative of the orientation of the hand part 33 and the detection values from the force sensor 34 in association with each other.

In step S306, the processor 11 determines whether or not the position of the hand part 33 coincides with the terminal point of the travel route indicated by the teaching information D.

If the processor 11 determines No in step S306, the processor 11 repeatedly carries out the operation in steps S304 and S305. By repeatedly carrying out the operation in steps S304 and S305, the detection values from the force sensor 34 obtained at various points included in the travel route are accumulated in the primary memory 12. Note that the various points included in the travel route mean the transit points included in the teaching information D or points on a route via which two adjacent transit points are connected to each other. If the processor 11 determines Yes in step S306, the processor 11 executes operation in next step S307.

In step S307, the processor 11 determines whether or not a detection value equal to or greater than a threshold is included in the detection values from the force sensor 34 which detection values are stored in the primary memory 12. Here, the thresholds are respectively defined for the detection values Fx, Fy, Fz, Mx, My, and Mz, which are obtained by the force sensor 34. The thresholds of the detection values may be identical to or different from those used in step S107 in the control method S1 or step S207 in the control method S2. For example, the thresholds of the detection values are smaller than the thresholds used in step S107 in the control method S1. With this, the teaching information D generated in accordance with a manipulation of the teacher U can be modified more precisely with use of the smaller thresholds, not in accordance with a manipulation of the teacher U.

If the processor 11 determines Yes in step S307, the processor 11 modifies the travel route with reference to the detection values from the force sensor 34 in step S308. Specifically, with reference to the detection value equal to or greater than the threshold, the processor 11 modifies the travel route indicated by the teaching information D. More specifically, for example, the processor 11 specifies, among the transit points included in the teaching information D, at least one transit point in the vicinity of the position associated with the detection value equal to or greater than the threshold. Then, the processor 11 modifies the position of the transit point thus specified, in accordance with the degree to which the detection value is greater than the detection value. Consequently, the travel route indicated by the teaching information D is modified. For example, the processor 11 modifies the x-coordinate of the position of the transit point in the vicinity of the position where the detection value Fx is equal to or greater than the threshold. In addition, for example, the processor 11 modifies the orientation of the hand part 33 about the x-axis at the transit point in the vicinity of the position where Mx is equal to or greater than the threshold. In this manner, the processor 11 modifies the position(s) of a transit point(s) in the vicinity of each position where at least any of the six detection values is equal to or greater than the threshold. The position where the detection value is equal to or greater than the threshold may not correspond, in a one-to-one relation, to the transit point to be modified. For example, the processor 11 may modify the positions of two or more transit points with respect to one position where a detection value is equal to or greater than a threshold. Alternatively, for example, the processor 11 may modify one transit point with respect to a plurality of positions at each of which a detection value is equal to or greater than a threshold (e.g., a region of the travel route in which region detection values are equal to or greater than thresholds). Further alternatively, for example, the processor 11 may add a new transit point in the vicinity of the position where the detection value is equal to or greater than the threshold.

The processor 11 modifies the travel route indicated by the teaching information D in this manner. Then, the processor 11 deletes the detection values obtained by the force sensor 34 which detection values are stored in the primary memory 12, and repeatedly carries out the processes from step S304. Thereafter, the hand part 33 moves along the travel route having been modified. If any of the detection values from the force sensor 34 becomes equal to or greater than the threshold while the hand part 33 is moving, the travel route is modified again.

If the processor 11 determines No in step S307, the processer 11 generates, in step S309, teaching information D corresponding to the travel route having been modified. Specifically, the processor 11 outputs the teaching information D including the travel route having been modified.

<Effects of Embodiment 2>

In accordance with Embodiment 2, it is possible to generate teaching information D used to teach an action to a robot with higher accuracy. The reasons for this will be described below.

For example, the travel route indicated by the teaching information D generated in accordance with a manipulation of the teacher U in the control method S1 does not always coincide with the travel route along which the hand part 33 has moved during teaching. For example, even in a case where the travel route from the transit point Pk to the transit point Pk+1 which travel route has been taught is not in a straight line, the travel route from the transit point Pk to the transit point Pk+1 which travel route is indicated by the teaching information D is in a straight line. Thus, these travel routes do not coincide with each other. Therefore, even if any of the detection values from the force sensor 34 does not exceed the threshold at the time of teaching in which the teaching information D is generated, one or some of the detection values may be equal to or greater than the threshold(s) when the hand part 33 is caused to move along the travel route indicated by the teaching information D.

In order to deal with this, in accordance with Embodiment 2, the hand part 33 is caused to move along the travel route indicated by the teaching information D generated in accordance with a manipulation of the teacher U, and the travel route is modified with reference to the detection values obtained by the force sensor 34 while the hand part 33 is moving. More specifically, in accordance with Embodiment 2, if any of the detection values obtained by the force sensor 34 while the hand part 33 is moving is equal to or higher than the threshold, the travel route is modified. The teaching information D corresponding to the travel route thus modified indicates a travel route in which more appropriate detection values can be obtained by the force sensor 34. As a result, by using the teaching information D generated in Embodiment 2, it is possible to teach an action to the robot 30 with higher accuracy.

[Modifications]

In each of Embodiments 1 and 2, the processor 11 may further execute a level recording process. Here, the level recording process refers to a process according to which level information indicative of a level of teaching carried out by a teacher U is recorded on the basis of a history of modification process. For example, the processor 11 causes the secondary memory 13 to store the level information in association with identification information of the teacher U. For example, the level information may indicate a higher level for a smaller number of times of execution of the adjustment process. In accordance with each of Embodiments 1 and 2 modified in this manner, it is possible to manage the level of teaching carried out by the teacher U.

In each of Embodiments 1 and 2, another output device may be employed in place of the display 40. Examples of the output device encompass a speaker, a light emitting diode (LED) lamp, and the like. For example, in the first output process and the second output process, the processor 11 may cause the speaker to output audio corresponding to the detection values obtained by the force sensor 34. In one example, if the detection values satisfy a certain condition (e.g., if any of the detection values is equal to or greater than the threshold), the processor 11 causes the speaker to emit a warning sound. Alternatively, for example, in the first output process and the second output process, the processor illuminates the LED lamp in accordance with the detection values from the force sensor 34. In one example, if the detection values satisfy a certain condition (e.g., if any of the detection values is equal to or greater than the threshold), the processor 11 illuminates the LED lamp.

In each of Embodiments 1 and 2, another end effector may be employed in place of the hand part 33. Examples of the end effector encompass an end effector used to carry out laser processing. The number of finger parts of the hand part 33 is not limited two, but may be three or more.

In each of Embodiments 1 and 2, the number of joints of the arm part 32 is not limited to three. For example, the arm part 32 may be an articulated arm made of two arms coupled to each other via one joint or an articulated arm made of three arms or five or more arms coupled to each other via two joints or four or more joints.

In the examples described in Embodiments 1 and 2, the certain condition used by the processor 11 to determine whether to execute the first stop process or the second stop process is the condition that at least any of the detection values from the force sensor 34 exceeds the threshold. However, the certain condition used in Embodiments 1 and 2 is not limited to the above-described condition, but may be a condition indicative of a state in which an inappropriate external force is applied to the end effector. The certain condition is defined in advance depending on the kind of the end effector employed, the kind of the work carried out with the end effector, the kind of the workpiece to be subjected to the work carried out with the end effector, or the like.

In the examples of Embodiments 1 and 2, the teacher U carries out teaching so that the detection values from the force sensor 34 become zero. However, appropriate values of the detection values from the force sensor 34 are not limited to zero. The appropriate values are values defined in accordance with the kind of the end effector employed, the kind of the work carried out with the end effector, the kind of the workpiece to be subjected to the work carried out with the end effector, or the like. The teacher U may carry out teaching such that the detection values from the force sensor become close to the appropriate values.

In each of Embodiments 1 and 2, the force sensor 34 may be incorporated into the arm part 32 or the hand part 33. The force sensor 34 may be integrated with the arm part 32 or the hand part 33.

In each of Embodiments 1 and 2, the force sensor 34 is not necessarily the one that can detect components of all the six axes.

In each of Embodiments 1 and 2, the manipulation device 50 is not limited to the configuration including the direction buttons and the confirmation button. The manipulation device 50 only needs to include a manipulation section for accepting a manipulation for moving the hand part 33.

In each of Embodiments 1 and 2, the dedicated controller 10 may execute a part of the processes to be executed by the robot controller 20. The robot controller 20 may execute a part of the processes to be executed by the dedicated controller 10. In this case, the control device in accordance with the present invention includes a plurality of processors, that is, a processor 11 and a processor 21. In this case, the control method in accordance with the present invention is executed by the plurality of processors, that is, the processor 11 and processor 21. The dedicated controller 10 and the robot controller 20 may be integrated with each other.

In Embodiment 2, the dedicated controller 10A may not execute the control method S1 but may execute the control method S2. In this case, for example, the dedicated controller 10A executes the control method S2 with respect to the teaching information D externally obtained, so as to modify the travel route indicated by the teaching information D. In this case, the robot control system 1A may not include the display 40 and the manipulation device 50.

### REFERENCE SIGNS LIST

1: Robot control system
10: Dedicated controller
20: Robot controller
11, 21: Processor
12, 22: Primary memory
13, 23: Secondary memory
14, 24: Communication interface
15, 25: Input-output interface
30: Robot
31: Mount
32: Arm part
34: Hand part
33: Force sensor
40: Display
50: Manipulation device
91: Protruded workpiece
92: Recessed workpiece

1. A control device for controlling a robot, comprising:
one or more processors; and
the robot including an arm part, a force sensor, and an end effector fixed to the arm part via the force sensor, wherein
the one or more processors are configured to execute (a) a moving process for causing the end effector to move and (b) a generation process for generating, with reference to a detection value from the force sensor, teaching information corresponding to a travel route of the end effector.

2. The control device as set forth in claim 1, wherein
in the generation process, the travel route of the end effector is modified with reference to the detection value from the force sensor so that the teaching information is generated to correspond to the travel route thus modified.

3. The control device as set forth in claim 1, wherein
the one or more processors are further configured to execute a first output process for outputting, to an output device, information indicative of the detection value from the force sensor on a real-time basis while the end effector is moving,
the moving process includes a first moving process for causing the end effector to move in accordance with a manipulation of a teacher with respect to a manipulation device, and
in the generation process, information indicative of the travel route of the end effector in the first moving process is generated as the teaching information.

4. The control device as set forth in claim 3, wherein
the output device is a display, and
the one or more processors are further configured to display, in the first output process, (a) an image of a virtual space in which an object corresponding to the end effector is disposed at a virtual position corresponding to a real position of the end effector and (b) information indicative of the detection value obtained when the end effector is at the real position.

5. The control device as set forth in claim 3, wherein
the one or more processors are further configured to execute a first stop process for causing the end effector to stop moving in a case where the one or more processors determine that the detection value satisfies a certain condition while the end effector is moving in the first moving process.

6. The control device as set forth in claim 3, wherein
the one or more processors are further configured to execute:
a storing process for causing a memory to store the teaching information indicative of the travel route of the end effector in the first moving process;
a second moving process for causing the end effector to move along with the travel route indicated by the teaching information;
a second stop process for causing the end effector to stop moving in a case where the one or more processors determine that the detection value satisfies a certain condition while the end effector is moving in the second moving process;
an adjustment process for adjusting, in accordance with a manipulation of the teacher with respect to the manipulation device, a position of the end effector at which position the end effector has stopped moving as a result of the second stop process;
a second output process for outputting, to the output device, information indicative of the detection value from the force sensor on a real-time basis while the end effector is moving in the adjustment process; and
a modification process for modifying the teaching information on a basis of the position adjusted by the adjustment process.

7. The control device as set forth in claim 6, wherein
the one or more processors are further configured to execute a level recording process for recording, in accordance with a history of the modification process having been executed, a level information indicative of a level of teaching carried out by the teacher.

8. A robot control system, comprising:
the control device recited in claim 3;
the robot;
the manipulation device; and
the output device.

9. A program for causing the control device recited in claim 1 to operate, the program causing the one or more processors to execute each of the processes.

10. A control method for causing one or more processors to control a robot that includes an arm part, a force sensor, and an end effector fixed to the arm part via the force sensor, said method comprising the steps of:
(a) the one or more processors causing the end effector to move; and
(b) the one or more processors generating, with reference to a detection value from the force sensor, teaching information corresponding to a travel route of the end effector.

11. The control method as set forth in claim 10, wherein
in the step (b), the one or more processors modify the travel route of the end effector with reference to the detection value from the force sensor so that the teaching information is generated to correspond to the travel route thus modified.

12. The control method as set forth in claim 10, further comprising the step of:
(c) the one or more processors outputting, to an output device, information indicative of the detection value from the force sensor on a real-time basis while the end effector is moving, wherein
the step (a) includes the step of (d) the one or more processors causing the end effector to move in accordance with a manipulation of the teacher with respect to a manipulation device, and
in the step (b), the one or more processors generate, as the teaching information, information indicative of a travel route of the end effector in the step (d).
